(19) United States
(12) Patent Application Publication
(10) Pub. No.: US 2012/0135160 A1
(43) Pub. Date: May 31, 2012

(54) Method for Production of Non-Adhesive-Type Flexible Laminate

(75) Inventor: Nobuhito Makino, Ibaraki (JP)

(73) Assignee: JX Nippon Mining & Metals Corporation, Tokyo (JP)

(21) Appl. No.: 13/355,603

(22) Filed: Jan. 23, 2012

Related U.S. Application Data
(62) Division of application No. 12/525,871, filed on Aug. 5, 2009.

(30) Foreign Application Priority Data
Mar. 20, 2007 (JP) 2007-072884

(51) Int. Cl. B05D 5/12; B05D 3/02; B05D 3/10

(52) U.S. Cl. 427/536

(57) ABSTRACT

A non-adhesive-type flexible laminate including a polyimide film with at least one surface thereof being plasma-treated, a tie-coat layer formed on the plasma-treated surface, and a metal conductor layer fanned on the tie-coat layer is provided. A ratio (T/Rz) of a tie-coat layer thickness (T) to a 10-point mean roughness (Rz) of the plasma-treated polyimide film surface is made to be 2 or more. This improves initial adhesion, which is an indicator of adhesion strength of the non-adhesive-type flexible laminate (in particular, a two-layered, flexible laminate), and also increases adhesion of the laminate after heat aging (i.e., after being allowed to stand for 168 hours at 150° C. for 168 hours in the atmosphere). A method of manufacturing the laminate is also provided.

### CROSS REFERENCE TO RELATED APPLICATIONS

This application is a divisional of co-pending U.S. application Ser. No. 12/525,871 which is the National Stage of International Application No. PCT/JP2008/051646, filed Feb. 1, 2008, which claims the benefit under 35 USC 119 of Japanese Application No. 2007-072884, filed Mar. 20, 2007.

### BACKGROUND

The present invention relates to a non-adhesive-type flexible laminate used as a packaging material for electronic parts such as flexible print substrates, TAB, and COF, and the invention also relates to a method for manufacturing the non-adhesive-type flexible laminate.

A FCCL (Flexible Copper Clad Laminate) in which a metal conductor layer mainly composed of copper is placed on top of a polyimide film has been widely used as a material for a circuit board in the electronic industry. Attention has been focused on a non-adhesive-type flexible laminate (in particular, a two-layered, flexible laminate) having no adhesive layer between a polyimide film and a metal layer with the advancement of the technology of realizing a fine-pitched circuit line width.

As a method for manufacturing a non-adhesive-type flexible laminate, in particular, one that is ideal for fine pitch, so-called “metalizing” is usually performed by which a metal layer is formed on a polyimide film in advance by dry plating such as sputtering, CVD, or vapor deposition, and a metal layer serving as a conductor layer is then formed by wet plating.

In metalizing, modifying for the purpose of removal of contaminants from the polyimide film surface and improvement of the surface roughness is carried out by plasma treatment of the polyimide film surface before formation of the metal surface to improve adhesion between the metal layer and the polyimide film (see Japanese Patent No. 3173511 and Published Japanese Translation No. 2003-519901 of a PCT International Publication).

This method is very effective, though there is the need for further improvement of the above-described method because it has been found that the method has a problem of degradation of adhesion caused by heat treatment at the time of formation of circuits, long-term use in the use environment and the like.

When the metal layer is formed on the polyimide film in advance by dry plating such as sputtering, consideration is generally given to improve adhesion and etching properties by selecting materials for an intermediate layer (see Japanese Patent Application Laid-Open Publication No. 6-120630). However, any further improvement has not been made from the viewpoint of heat treatment at the time of formation of circuits, long-term use in the use environment and the like.

Furthermore, a polyimide film with a metal membrane used for TAB or FPC, which is obtained by chemically etching the surface of a polyimide film to roughen the surface and then forming an under-layer on the polyimide film and a copper deposition layer on the under-layer, is suggested (see Japanese Patent Application Laid-Open Publication No. 6-210794). However, the surface roughening processing for this technique is performed merely by chemical etching and cannot solve the specific problem with plasma treatment of the polyimide film surface.

### SUMMARY OF THE INVENTION

An object of the present invention is not only to improve initial adhesion which is an indicator of adhesion of a non-adhesive-type flexible laminate (in particular, a two-layered, flexible laminate), but also to increase adhesion of the non-adhesive-type flexible laminate after heat aging (after being allowed to stand at 150° C. for 168 hours in the atmosphere).

In order to achieve the above-described object, the present invention provides a non-adhesive-type flexible laminate and a method for manufacturing such a non-adhesive-type flexible laminate. The non-adhesive-type flexible laminate comprises a polyimide film with at least one surface being plasma-treated, a tie-coat layer formed on the plasma-treated surface, and a metal conductor layer formed on the tie-coat layer, characterized in that a proportion (T/Rz) of the tie-coat layer thickness (T) to 10-point mean roughness (Rz) of the plasma-treated polyimide film surface is 2 or more. The “tie-coat layer” used herein means an intermediate layer for improving adhesion between the polyimide film layer and the metal conductor layer. The term “tie-coat layer” is also used in Japanese Patent No. 3173511 mentioned above and is known to be a common technical term. The term “tie-coat layer” is used in this specification.

Any one of nickel, chromium, cobalt, a nickel alloy, a chromium alloy, and a cobalt alloy can be used as the tie-coat layer. Any of the above-mentioned materials can increase adhesion between the polyimide film layer and the metal conductor layer. Furthermore, they can be etched when designing a circuit. These materials are useful when manufacturing the non-adhesive-type flexible laminate. However, it should be understood that selection of materials other than those listed above cannot be negated.

Copper or a copper alloy can be used as the metal conductor layer. Similarly, in this case, selection of materials other than those listed above cannot be negated.

It is important in the present invention to make a proportion (T/Rz) of the tie-coat layer thickness (T) to 10-point mean roughness (Rz) of the plasma-treated polyimide film surface to be 2 or more. As a result, not only initial adhesion which is an indicator of adhesion of the non-adhesive-type flexible laminate can be improved, but also adhesion strength after heat aging (after being allowed to stand at 150° C. for 168 hours in the atmosphere) can be increased. The reason for the improvement of the initial adhesion and the adhesion strength will be explained later.

Furthermore, it is preferable that a proportion (T/Rz) of the tie-coat layer thickness (T) to 10-point mean roughness (Rz) of the plasma-treated polyimide film surface is 4 or more. Under this condition, the adhesion strength after heat aging (after being allowed to stand at 150° C. for 168 hours in the atmosphere) can be further increased.

Furthermore, it is preferable according to the invention that the 10-point mean roughness (Rz) of the polyimide film surface is 2.5 to 20 nm and that the tie-coat layer thickness (T) is 5 to 100 nm or 10 to 100 nm.

With regard to the above-described conditions in manufacturing a non-adhesive-type flexible laminate according to the present invention, it is necessary and obvious that a proportion (T/Rz) of the tie-coat layer thickness (T) to 10-point mean roughness (Rz) of the plasma-treated polyimide film surface is made to be 2 or more; and preferably, adjustment should be made so that the proportion T/Rz can reach 4 or more.

According to the invention, initial adhesion strength between the polyimide film and the metal layer after laminating them together in the non-adhesive-type flexible laminate, in which the tie-coat layer and the metal conductor layer are formed on the plasma-treated surface of the polyimide film, is required to be 0.6 kN/m or more, and adhesion between the polyimide film and the metal layer after heating the non-adhesive-type flexible laminate at 150° C. for 168 hours in the atmosphere is required to be 0.4 kN/m or more. Furthermore, it is preferable that the adhesion after heating the non-adhesive-type flexible laminate at 150° C. for 168 hours in the atmosphere is 0.5 kN/m or more. The non-adhesive-type flexible laminate according to this invention satisfies the above-described conditions.

Furthermore, the present invention provides a method for manufacturing a non-adhesive-type flexible laminate, characterized in that after at least one surface of a polyimide film being plasma-treated so as to make 10-point mean roughness (Rz) of the polyimide film surface become 2.5 to 20 nm, a tie-coat layer of 5 to 100 nm thickness is formed so that a proportion (T/Rz) of the tie-coat layer thickness (T) to 10-point mean roughness (Rz) of the plasma-treated polyimide film surface will be 2 or more; and then a metal conductor layer is formed on the tie-coat layer, wherein initial adhesion between the polyimide film and the metal layer after laminating them together is 0.6 kN/m or more, and adhesion after heating the non-adhesive-type flexible laminate at 150° C. for 168 hours in the atmosphere is 0.4 kN/m or more.

As described above, the present invention has the excellent effect of improving initial adhesion between the polyimide film and the metal layer after laminating them together and improving adhesion between the polyimide film and the metal layer after heat aging by adjusting 10-point mean roughness (Rz) of the polyimide film surface and the thickness of the tie-coat layer (T).

### BRIEF DESCRIPTION OF THE DRAWINGS

FIG. 1 is a diagram showing the relationship between initial adhesion (normal peel strength) and the film thickness;

FIG. 2 is a diagram showing the result of measurement of adhesion (heat-resistant peel strength) after heat aging (heating at 150° C. for 168 hours in the atmosphere); and

FIG. 3 is a diagram showing the relationship between a proportion of the tie-coat layer thickness (T) to surface roughness (Rz) and adhesion.

### DETAILED DESCRIPTION OF THE PRESENT INVENTION

Next, specific examples of the present invention will be explained. The following explanation is given in order to facilitate understanding of the invention, and the essence of the invention will not be limited by this explanation. In other words, the following explanation includes other aspects or modifications to be contained in this invention.

The basis of the invention is to manufacture a non-adhesive-type flexible laminate by forming a tie-coat layer on at least one surface of a polyimide film and forming a metal conductor layer on the tie-coat layer surface. As a result of removal of contaminants from the surface and modification of the surface by means of plasma-treating, the polyimide film surface roughness increases.

By acquiring the relationship between plasma treatment conditions and the surface roughness in advance, a polyimide film having desired surface roughness can be obtained by plasma treatment under specified conditions.

In the case of plasma treatment, for example, the higher the plasma power is, the larger the surface roughness Rz becomes. As a result of thorough examination of various types of polyimide films by the inventors of the present invention, it has been found that the surface roughness can be adjusted to within the range of 2.5 to 20 nm although it may vary depending on different materials for the polyimide film and different values of initial surface roughness. This condition is a preferred range for this invention.

Therefore, according to one embodiment of the invention, the surface roughness can be adjusted by finding the relationship between the plasma treatment conditions and the surface roughness in advance so that T/Rz for the polyimide film surface after plasma treatment becomes 2 or more, and preferably 4 or more.

If T/Rz is less than 2, the tie-coat layer thickness is not sufficient for the surface roughness. In this case, recesses in the polyimide film surface after the plasma treatment are not sufficiently covered with the tie-coat layer, thereby causing spaces to be generated; or such phenomenon of causing the thickness of the tie-coat layer over protruding areas of the polyimide film to become thinner may take place. As a result, after heat aging is performed, weak areas where adhesion with the polyimide film was not sufficient when the tie-coat layer was formed tends to easily deteriorate. The above-described condition is important for the present invention.

The initial adhesion strength between the polyimide film and the metal conductor layer after laminating them together in the non-adhesive-type flexible laminate, in which the tie-coat layer and the metal conductor layer are formed on the plasma-treated surface of the polyimide film, is generally measured as “normal peel strength.” This normal peel strength does not depend on the plasma-treated surface roughness if the plasma-treated surface roughness is within the range of 2.5 to 20 nm. However, if the tie-coat layer is not applied, the normal peel strength will decrease approximately by half.

On the other hand, the adhesion strength after heat aging (heat-resistant peel strength) will influence the plasma-treated surface roughness greatly. As the surface roughness increases, the adhesion after heating the laminate at 150° C. for 168 hours in the atmosphere will decrease to less than 0.5 kN/m, and further down to less than 0.4 kN/m.

Regarding the phenomenon that takes place between the layers, it has been found that larger surface roughness shows rapid progress of diffusion from the metal conductor layer to the polyimide film, but greater diffusion from the metal conductor layer to the polyimide film makes the heat-resistant peel strength weaker.

Meanwhile, it is known that there are two modes of separation in normal peeling: separation near a metal/polyimide interface (adhesive failure); and separation inside the polyimide (cohesive failure); however, which mode will occur and which mode is stronger are not necessarily clear. Generally, it is believed that adhesive strength will increase with the enhancement of plasma treatment and that deterioration caused by damage to the polyimide (such as WBL) will also grow.

So, it is apparent that the method of strengthening adhesion between the tie-coat layer and the metal conductor layer by increasing electric power for the plasma treatment and thereby increasing the surface roughness of the polyimide film is not necessarily effective.

The present invention solves the above-described problem by making a proportion (T/Rz) of the tie-coat layer thickness (T) to 10-point mean roughness (Rz) of the plasma-treated polyimide film surface in a non-adhesive-type flexible laminate, which is constituted from a plasma-treated polyimide film, a tie-coat layer formed on the plasma-treated surface, and a metal conductor layer formed on the tie-coat layer, will be 2 or more.

This is done by controlling plasma power, which is the major reason for enabling to improve both the initial adhesion between the polyimide film and the metal layer after laminating them together and the adhesion after heat aging.

### EXAMPLES

Next, an explanation will be given based on an example and a comparative example. This example is just one example and the present invention is not limited only to this example. In other words, this example includes other aspects or modifications to be contained in this invention.

There is no particular limitation on materials to be used for a polyimide film. The present invention can be applied with any of polyimide films on the market such as UPILEX by Ube Industries, Ltd., Kapton by DU PONT-TORAY CO., LTD., and Apical by Kaneka Corporation, for example. The invention is not limited to these specific product types. In an example and a comparative example of this invention, UPILEX-SGA made by Ube Industries, Ltd. was used as a polyimide film.

The polyimide film was set in a vacuumed device, which was then evacuated, and oxygen was introduced into a chamber and pressure thereof was adjusted to 10 Pa.

Polyimide films with different surface roughness values were manufactured by changing electric power conditions for plasma treatment. As shown in FIG. 1, four types of surface roughness Rz within the range of 5.1 nm to 9.9 nm were prepared.

The surface roughness after the plasma treatment was measured, using a device and under the following measurement conditions:
Device: scanning prove microscope SPM-9600 by Shimadzu Corporation
Conditions: Dynamic mode
   Scanning range 1 μm×1 μm
   Number of pixels 512×512.

Next, a tie-coat layer (Ni-20 wt % Cr) with thickness thereof was changed within the range of 0 to 40 nm (400 Å) was formed on the plasma-treated polyimide film surface obtained above by sputtering, and then a copper layer (3000 Å) was formed on the tie-coat layer by sputtering.

Furthermore, a metal conductor layer (8 μm thick) made of copper was formed on the surface of the tie-coat layer by electroplating, thereby manufacturing a two-layered, flexible laminate.

Initial adhesion of the above-obtained samples and adhesion thereof after heat aging (after being allowed to stand at 150° C. for 168 hours in the atmosphere) were measured. The adhesion was measured by JIS C 6471 (a method for testing copper-clad laminates for flexible printed circuit boards).

FIG. 1 shows the relationship between the initial adhesion (normal peel strength) and the tie-coat film thickness when the surface roughness was changed. As shown in FIG. 1, when no tie-coat layer was applied, the maximum peel strength was 0.4 kN/m, and the value showed reduction approximately by half compared to the case where the tie-coat layer was applied.

The initial adhesion, i.e., “normal peel strength”, between the polyimide film and the metal layer after laminating them together in the non-adhesive-type flexible laminate, in which the tie-coat layer and the metal conductor layer were formed on the plasma-treated surface of the polyimide film, exceeded 0.6 kN/m.

This shows that when the tie-coat layer is formed, the normal peel strength does not depend on the thickness or surface roughness of the tie-coat layer. It is apparent that the normal peel strength, i.e., the initial adhesion, between the polyimide film and the metal layer after laminating them together is not directly influenced by the plasma-treated surface roughness.

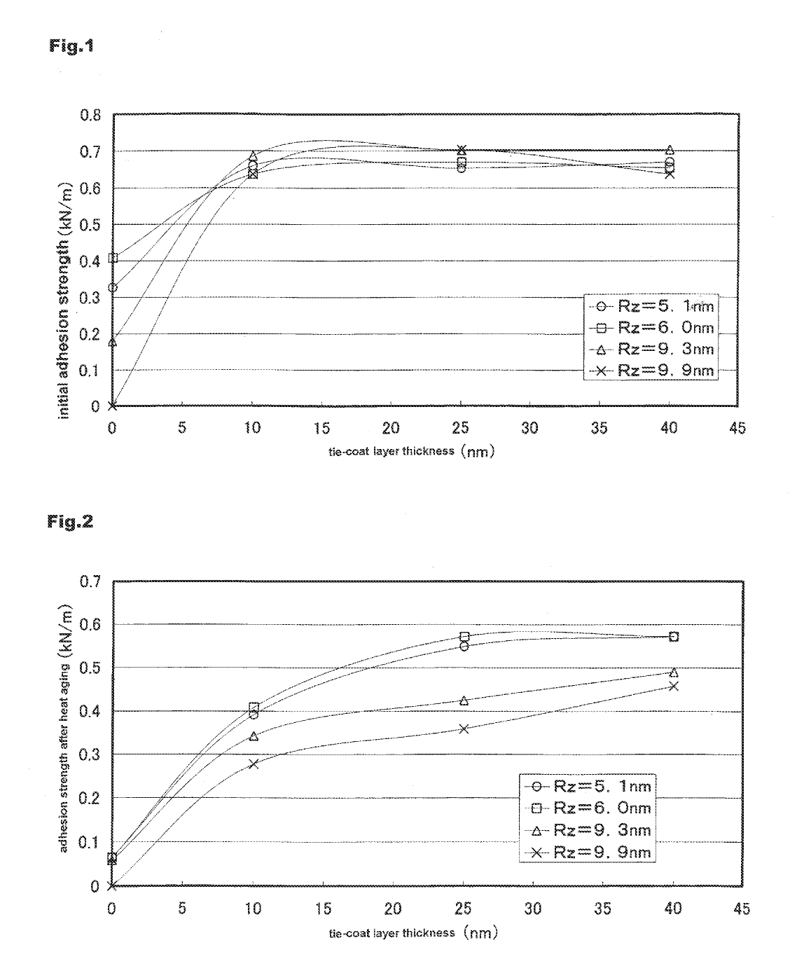

Next, FIG. 2 shows the result of measurement of the adhesion after heat aging (heating at 150° C. for 168 hours in the atmosphere) (heat-resistant peel strength). As shown in FIG. 2, the heat-resistant peel strength greatly influenced the plasma-treated surface roughness.

When the film thickness of the tie-coat layer was 10 nm (100 Å), the adhesion after heating the laminate at 150° C. for 168 hours in the atmosphere reduced to less than 0.4 kN/m. The greater the surface roughness became, the more considerably the above-mentioned heat-resistant peel strength reduced.

On the other hand, the heat-resistant peel strength was improved with the increase of film thickness of the tie-coat layer. FIG. 2 shows that the adhesion can be made to be even 0.5 kN/m or more.

As a result, it was found that the heat-resistant peel strength can be improved by examining a correlation between the surface roughness (Rz) and the tie-coat layer thickness (T) and then satisfying certain standards based on that examination.

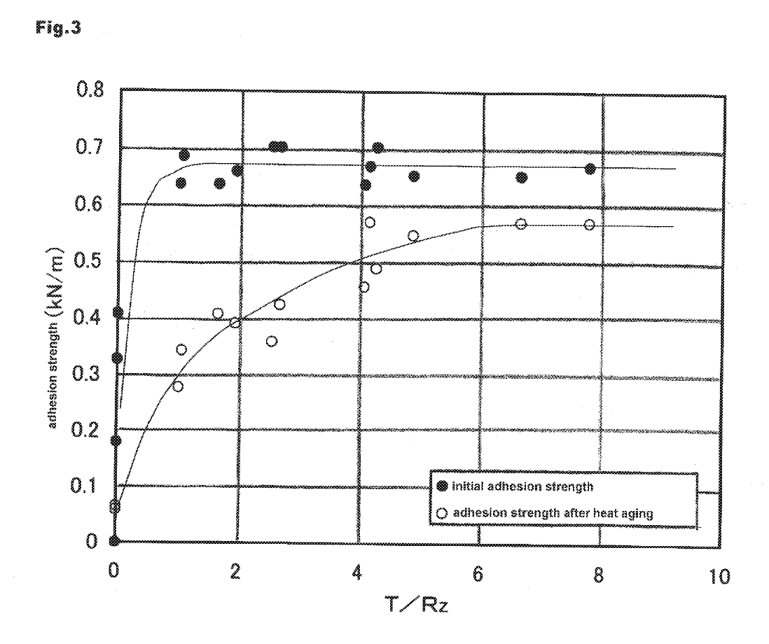

FIG. 3 shows the relationship between T/Rz and adhesion. As is apparent from FIG. 3, the initial adhesion was 0.6 kN/m or more in all cases except the case of T/Rz=0 (no tie-coat layer), which means that a desired value of the initial adhesion was obtained.

On the other hand, as shown in FIGS. 1 and 2 described above, the adhesion after heat aging was less than 0.1 kN/m in the case of T/Rz=0 and was less than 0.4 kN/m in the case of T/Rz<2; and with the increase of T/Rz, the adhesion after heat aging improved to reach and stay nearly constantly at 0.5 to 0.6 kN/m when T/Rz was 4 or more (T/Rz≧4).

The Rz value shown in FIGS. 1 and 2 was calculated based on the previously found relationship between the plasma power and the surface roughness after the plasma treatment. When the two-layered, flexible laminate was manufactured according to the above-described example by applying surface treatment with plasma power to realize Rz=5.1 nm, an actual measurement value of the surface roughness of the polyimide film after removing the metal conductor layer and the tie-coat layer from the two-layered, flexible laminate by etching was 5.5 nm, which matched the above-calculated value well. Incidentally, a cupric chloride etchant was used for etching.

The adhesion after heat aging should preferably be 0.4 kN/m or more, and preferably 0.5 kN/m or more. The initial adhesion can be made to become 0.6 kN/m or more and the adhesion after heat aging can be made to become 0.4 kN/m by manufacturing the non-adhesive-type flexible laminate so that T/Rz becomes 2 or more (T/Rz≧2), and preferably 4 or more (T/Rz≧4).

The present invention solves the above-described problem by making a proportion (T/Rz) of the thickness of a tie-coat layer (T) to 10-point mean roughness (Rz) of the surface of a plasma-treated polyimide film will be 2 or more with regard to a non-adhesive-type flexible laminate constituted from the plasma-treated polyimide film, the tie-coat layer formed on the plasma-treated surface, and a metal conductor layer formed on the tie-coat layer. The effectiveness of the present invention can be confirmed as described above.

The present invention has the excellent effect of improving the initial adhesion between a polyimide film and a metal layer after laminating them together and improving adhesion between the polyimide film and the metal layer after heat aging by adjusting 10-point mean roughness (Rz) of the polyimide film surface and the thickness of a tie-coat layer (T); therefore, is useful as a non-adhesive-type flexible laminate for application of a packaging material for electronic parts such as flexible print substrates, TAB, and COF.

I claim:

1. A method for manufacturing a non-adhesive-type flexible laminate, characterized in that a tie-coat layer of 5 to 100 nm thickness is formed so that a ratio (T/Rz) of the tie-coat layer thickness (T) to 10-point mean roughness (Rz) of the plasma-treated polyimide film surface will be 2 or more after at least one surface of a polyimide film is plasma-treated so as to make 10-point mean roughness (Rz) of the polyimide film surface become 2.5 to 6.0 nm; and then a metal conductor layer is formed on the tie-coat layer, wherein initial adhesion between the polyimide film and the metal layer after lamination is 0.6 kN/m or more, and adhesion after heating the non-adhesive-type flexible laminate at 150° C. for 168 hours in the atmosphere is 0.5 kN/m or more.

2. A method of manufacturing a non-adhesive-type flexible laminate, comprising the steps of:
plasma-treating at least one surface of a polyimide film so as to make a 10-point mean roughness (Rz) of the polyimide film surface 2.5 to 6.0 nm;
after said plasma-treating step, forming a tie-coat layer of 5 to 100 nm thickness (T) on the plasma-treated polyimide film surface such that a ratio (T/Rz) of the tie-coat layer thickness (T) to the 10-point mean roughness (Rz) of the plasma-treated polyimide film surface is 2 or more; and
forming a metal conductor layer on the tie-coat layer.

3. The method according to claim 2, wherein an initial adhesion between the polyimide film and the metal conductor layer provided during said step of forming the metal conductor layer on the tie-coat layer is 0.6 kN/m or more.

4. The method according to claim 3, wherein an adhesion after heating the non-adhesive-type flexible laminate at 150° C. for 168 hours in the atmosphere is 0.5 kN/m or more.

5. The method according to claim 3, wherein the metal conductor layer is copper or a copper alloy.

6. The method according to claim 3, wherein the ratio (T/Rz) of the tie-coat layer thickness (T) to the 10-point mean roughness (Rz) of the plasma-treated polyimide film surface provided during said step of forming the tie-coat layer is 4 or more.

7. The method according to claim 3, wherein said plasma-treating step is oxygen plasma treatment.

8. The method according to claim 3, wherein the tie-coat layer thickness (T) provided during said step of forming said tie-coat layer is 10 to 100 nm.

9. The method according to claim 3, wherein the tie-coat layer is formed of a material selected from the group consisting of nickel, chromium, cobalt, a nickel alloy, a chromium alloy, and a cobalt alloy.
